(19) United States
(12) Patent Application Publication
(10) Pub. No.: US 2013/0243313 A1
(43) Pub. Date: Sep. 19, 2013

(54) METHOD AND SYSTEM FOR IMAGES FOREGROUND SEGMENTATION IN REAL-TIME

(71) Applicants: Jaume Civit, Madrid (ES); Oscar Divorra, Madrid (ES)

(72) Inventors: Jaume Civit, Madrid (ES); Oscar Divorra, Madrid (ES)

(73) Assignee: TELEFONICA, S.A., Madrid (ES)

(21) Appl. No.: 13/877,020

(22) PCT Filed: Aug. 11, 2011
(86) PCT No.: PCT/EP11/04021

§ 371 Date: May 29, 2013

(30) Foreign Application Priority Data
Oct. 1, 2010 (EP) 10380122.1
Oct. 8, 2010 (ES) P 201001297

(51) Int. Cl. G06T 5/00

(52) U.S. Cl. CPC G06T 5/002
USPC 382/164

(57) ABSTRACT

The method comprises:
generating a set of cost functions for foreground, background and shadow segmentation classes or models, where the background and shadow segmentation models are a function of chromatic distortion and brightness and colour distortion, and where said cost functions are related to probability measures of a given pixel or region to belong to each of said segmentation classes; and
applying to pixel data of an image said set of generated cost functions;
   The method further comprises defining said background and shadow segmentation cost functionals introducing depth information of the scene said image has been acquired of.

The system comprises camera means intended for acquiring, from a scene, colour and depth information, and processing means intended for carrying out said foreground segmentation by hardware and/or software elements implementing the method.

### FIELD OF THE ART

The present invention generally relates, in a first aspect, to a method for images real-time foreground segmentation, based on the application of a set of cost functions, and more particularly to a method which comprises defining said cost functions introducing colour and depth information of the scene the analysed image or images have been acquired of.

A second aspect of the invention relates to a system adapted to implement the method of the first aspect, preferably by parallel processing.

### PRIOR STATE OF THE ART

Foreground segmentation is an operation key for a large range of multi-media applications. Among other, silhouette based 3D reconstruction and real-time depth estimation for 3D video-conferencing are applications that can greatly profit from flickerless foreground segmentations with accurate borders and resiliency to noise and foreground shade changes. However, simple colour based foreground segmentation, while it can rely on interestingly robust algorithm designs, it can have troubles in regions with shadows over the background or on foreground areas with low colour difference with respect to the background. The additional use of depth information can be of key importance in order to solve such ambiguous situations.

Also, depth-only based segmentation is unable to give an accurate foreground contour and has trouble on dark regions. This is strongly influenced by the quality of the Z/Depth data obtained from current depth acquisition systems such as ToF (Time of Flight) cameras such as SR4000. Furthermore, without colour information, modelling shadows becomes a significant challenge.

### TECHNICAL BACKGROUND/EXISTING TECHNOLOGY

Foreground segmentation has been studied from a range of points of view (see references [3, 4, 5, 6, 7]), each having its advantages and disadvantages concerning robustness and possibilities to properly fit within a GPGPU. Local, pixel based, threshold based classification models [3, 4] can exploit the parallel capacities of GPU architectures since they can be very easily fit within these. On the other hand, they lack robustness to noise and shadows. More elaborated approaches including morphology post-processing [5], while more robust, they may have a hard time exploiting GPUs due to their sequential processing nature. Also, these use strong assumptions with respect to objects structure, which turns into wrong segmentation when the foreground object includes closed holes. More global-based approaches can be a better fit such that [6]. However, the statistical framework proposed is too simple and leads to temporal instabilities of the segmented result. Finally, very elaborated segmentation models including temporal tracking [7] may be just too complex to fit into real-time systems. None of these techniques is able to properly segment foregrounds with big regions with colours similar to the background.
[2, 3, 4, 5, 6]: Are colour/intensity-based techniques for foreground, background and shadow segmentation. Most of the algorithms are based on colour models which separate the brightness from the chromaticity component, or based on background subtraction aiming at coping with local illumination changes, such as shadows and highlights, as well as global illumination changes. Some approaches use morphological reconstruction steps in order to reduce noise and misclassification by assuming that the object shapes are properly defined along most part of their contours after the initial detection, and considering that objects are closed contours with no holes inside. In some cases, a global optimization step is introduced in order to maximize the probability of proper classification. In any case, none of these techniques is able to properly segment foregrounds with big regions with colours similar to the background. Indeed, ambiguous situations where foreground and background have similar colours will lead to miss-classifications.
[13], [12]: Introduce in some way the use of depth in their foreground segmentation. In them, though, depth is fully assumed to determine foreground. Indeed, they assume that the more in the front is an object, the more likely to be in the foreground. In practice, this may be incorrect in many applications since background (understood as the static or permanent components in a scene) may have objects that are closer to the camera than the foreground (or object of interest to segment). Also, these lack of a fusion of colour and depth information, not exploiting the availability of multi-modal visual information.
   Problems with Existing Solutions

In general, current solutions have trouble on putting together, good, robust and flexible foreground segmentation with computational efficiency. Either methods available are too simple, either they are excessively complex, trying to account for too many factors in the decision whether some amount of picture data is foreground or background. This is the case for the overview of the state of the art here exposed. See a discussion one by one:
[2, 3, 4, 5, 6]: None of these techniques is able to properly segment foregrounds with big regions with colours similar to the background. Indeed, ambiguous situations where foreground and background have similar colours will lead to miss-classifications.
[13], [12] Introduce in some way the use of depth in their foreground segmentation. In them, though, depth is fully assumed to determine foreground. Indeed, they assume that the more in the front is an object, the more likely to be in the foreground. In practice, this may be incorrect in many applications since background (understood as the static or permanent components in a scene) may have objects that are closer to the camera than the foreground (or object of interest to segment). Also, these lack of a fusion of colour and depth information, not exploiting the availability of multi-modal visual information.

All these techniques are unable to resolve segmentation when the foreground contains big regions with colours that are very similar to the background.

### DESCRIPTION OF THE INVENTION

It is necessary to offer an alternative to the state of the art which covers the gaps found therein, overcoming the limitations expressed here above, allowing to have a segmentation framework for GPU enabled hardware with improved quality and high performance and with taking into account both colour and depth information.

To that end, the present invention provides, in a first aspect, a method for images foreground segmentation in real-time, comprising:
generating a set of cost functions for foreground, background and shadow segmentation classes or models, where the background and shadow segmentation costs are a function of chromatic distortion and brightness and colour distortion, and where said cost functions are related to probability measures of a given pixel or region to belong to each of said segmentation classes; and
applying to pixel data of an image said set of generated cost functions.

The method of the first aspect of the invention differs, in a characteristic manner, from the prior art methods, in that it comprises defining said background and shadow segmentation cost functionals by introducing depth information of the scene said image has been acquired of.

For an embodiment of the method of the first aspect of the invention, said depth information is a processed depth information obtained by acquiring rough depth information with a Time of Flight, ToF, camera and processing it to undistort, rectify and scale it up to fit with colour content, regarding said image, captured with a colour camera. For an alternative embodiment, the method comprises acquiring both, colour content, regarding said image, and said depth information with one and only camera able to acquire and supply colour and depth information.

For an embodiment, the method of the invention comprises defining said segmentation models according to a Bayesian formulation.

According to an embodiment the method of the invention comprises, in addition to a local modelling of foreground, background and shadow classes carried out by said cost functions where image structure is exploited locally, exploiting the spatial structure of content of at least said image in a more global manner.

Said exploiting of the local spatial structure of content of at least said image is carried out, for an embodiment, by estimating costs as an average over homogeneous colour regions.

The method of the first aspect of the invention further comprises, for an embodiment, applying a logarithm operation to the probability expressions, or cost functions, generated in order to derive additive costs.

According to an embodiment, the mentioned estimating of pixels' costs is carried out by the next sequential actions:
i) over-segmenting the image using homogeneous colour criteria based on a k-means approach;
ii) enforcing a temporal correlation on k-means colour centroids, in order to ensure temporal stability and consistency of homogeneous segments, and
iii) computing said cost functions per homogeneous colour segment.
   And said exploiting of the spatial structure of content of the image in a more global manner is carried out by the next action:
iv) using an optimization algorithm to find the best possible global solution by optimizing costs.

In the next section different embodiments of the method of the first aspect of the invention will be described, including specific cost functions defined according to Bayesian formulations, and more detailed descriptions of said steps i) to iv).

The present invention thus provides a robust hybrid Depth-Colour Foreground Segmentation approach, where depth and colour information are locally fused in order to improve segmentation performance, which can be applied, among others, to an immersive 3D Multiperspective Telepresence system for Many-to-Many communications with eye-contact.

As disclosed above, the invention is based on a costs minimization of a set of probability models (i.e. foreground, background and shadow) by means, for an embodiment, of Hierarchical Belief Propagation.

For some embodiments, which will be explained in detail in a subsequent section, the method includes outlier reduction by regularization on over-segmented regions. A Depth-Colour hybrid set of background, foreground and shadow Bayesian cost models have been designed to be used within a Markov Random Field framework to optimize.

The iterative nature of the method makes it scalable in complexity, allowing it to increase accuracy and picture size capacity as computation hardware becomes faster. In this method, the particular hybrid depth-colour design of cost models and the algorithm implementing the method actions is particularly suited for efficient execution on new GPGPU hardware.

A second aspect of the invention provides a system for images foreground segmentation in real-time, comprising camera means intended for acquiring images from a scene, including colour information, processing means connected to said camera to receive images acquired there by, and to process them in order to carry out a real-time images foreground segmentation.

The system of the second aspect of the invention differs from the conventional systems, in a characteristic manner, in that said camera means are also intended for acquiring, from said scene, depth information, and in that said processing means are intended for carrying out said foreground segmentation by hardware and/or software elements implementing at least part of the actions of the method of the first aspect, including said applying of said cost functions to images pixel data.

For an embodiment, said hardware and/or software elements implement steps i) to iv) of the method of the first aspect.

Depending on the embodiment, said camera means comprises a colour camera for acquiring said images including colour information, and a Time of Flight, ToF, camera for acquiring said depth information, or the camera means comprises one and only camera able to acquire and supply colour and depth information.

Whatever the embodiment, the camera or cameras used need to be capable of capturing both colour and depth information, and these be processed together by the system provided by this invention.

### BRIEF DESCRIPTION OF THE DRAWINGS

The previous and other advantages and features will be more fully understood from the following detailed description of embodiments, some of which with reference to the attached drawings, which must be considered in an illustrative and non-limiting manner, in which:

FIG. 1 shows schematically the functionality of the invention, for an embodiment where a foreground subject is segmented out of the background, where the left views correspond to a colour only segmentation of the scene, and the right views correspond to an hybrid depth and colour segmentation of the scene, i.e. to the application of the method of the first aspect of the invention;

FIG. 2 is an algorithmic flowchart for a full video sequence segmentation according to an embodiment of the method of the first aspect of the invention;

FIG. 3 is an algorithmic flowchart for 1 frame segmentation;

FIG. 4 is a segmentation algorithmic block architecture;

FIG. 5 illustrates an embodiment of the system of the second aspect of the invention; and

FIG. 6 shows, schematically, another embodiment of the system of the second aspect of the invention.

### DETAILED DESCRIPTION OF SEVERAL EMBODIMENTS

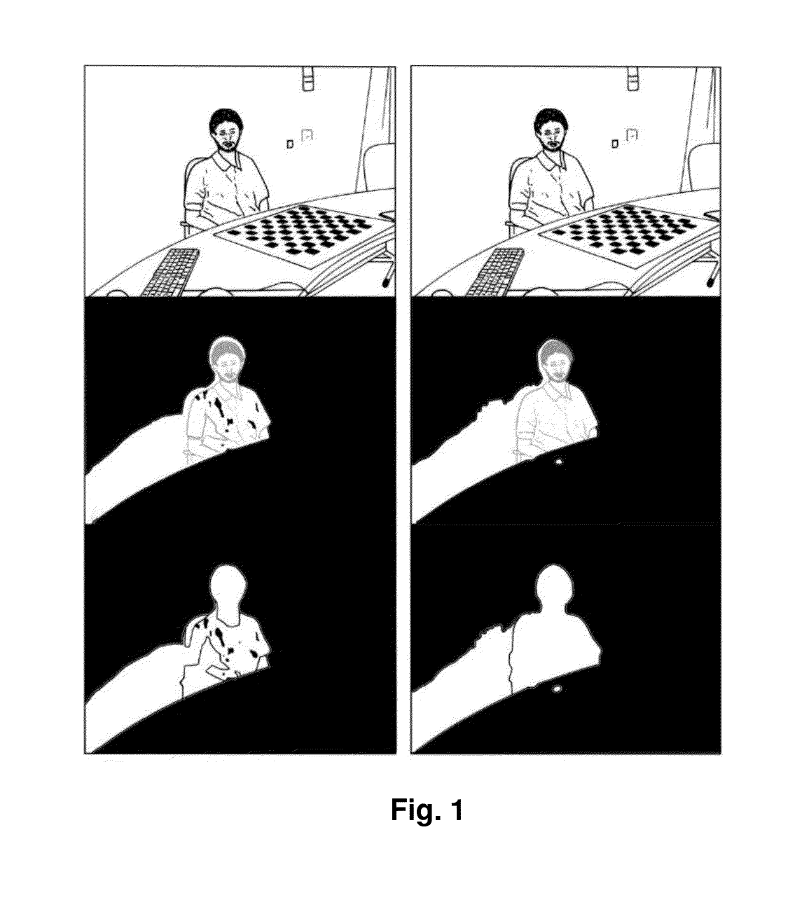

Upper views of FIG. 1 shows schematically a colour image (represented in greys to accomplish with formal requirements of patents offices) on which the method of the first aspect of the invention has been applied, in order to obtain the foreground subject segmented out of the background, as illustrated by bottom right view of FIG. 1, by performing a carefully studied sequence of image processing operations that lead to an enhanced and more flexible approach for foreground segmentation (where foreground is understood as the set of objects and surfaces that lay in front of a background).

The functionality that this invention implements is clearly described by right views of FIG. 1, where a foreground subject is segmented out of the background. The right top picture represents the scene, the right middle picture shows the background (black), the shadow (grey) and the foreground with the texture overlayed, the right lower picture shows the same as the middle but with the foreground labelled with white.

Comparing said right middle and lower views with the left middle and lower views, corresponding to a colour only segmentation, one can see clearly how the right views obtained with the method of the first aspect of the invention significantly improves the obtained result.

Indeed, the light colour of the subject shirt of FIG. 1 makes it difficult for a colour only segmentation algorithm to properly segment foreground from background and from shadow. Basically, if one tries to make the algorithm more sensitive to select foreground over the shirt, then while segmentation continues poor for the foreground, regions from the shadow on the wall get merged into the foreground, as is the case of left middle and lower vies, where grey and black areas overrun the subject's body.

That shadow merging into the foreground does not happen on right middle and lower views of FIG. 1, which proves that by means of colour and depth data fusion, foreground segmentation appears to be much more robust, and high resolution colour data ensures good border accuracy and proper dark areas segmentation.

In the method of the first aspect of the invention, the segmentation process is posed as a cost minimization problem. For a given pixel, a set of costs are derived from its probabilities to belong to the foreground, background or shadow classes. Each pixel will be assigned the label that has the lowest associated cost:

$${Pixel}_{Label} ( \vec{C} ) = {arg min}_{α ∈ \{ BG , FG , SH \}} \{ {Cost}_{α} ( \vec{C} ) \} .$$

In order to compute these costs, a number of steps are being taken such that they are as free of noise and outliers as possible. In this invention, this is done by computing costs region-wise on colour, temporally consistent, homogeneous areas followed by a robust optimization procedure. In order to achieve a good discrimination capacity among background, foreground and shadow, foreground, background and shadow Bayesian costs have been designed based on the fusion of colour and depth information.

In order to define the set of cost functions corresponding to the three segmentation classes, they have been built upon [5]. However, according to the method of the invention, the definitions of Background and Shadow costs are redefined in order to make them more accurate and reduce the temporal instability in the classification phase. In this invention, Background and Shadow cost functionals introduce additional information that takes depth information from a ToF camera into account. For this, [3] has been revisited to thus derive equivalent background and shadow probability models based on chromatic distortion (3), colour distance and brightness (2) measures. As shown in the following, a depth difference term is also included in Background and Shadow cost expressions in order to account for 3D information. Unlike in [3] though, where classification functionals were fully defined to work on a threshold based classifier, the cost expressions of the method of the invention are formulated from a Bayesian point of view. This is performed such that additive costs are derived after applying the logarithm to the probability expressions found. Thanks to this, cost functionals are then used within the optimization framework chosen for this invention. In an example, brightness and colour distortion (with respect to a trained background model) are defined as follows. First, brightness (BD) is such that

$$BD ( \vec{C} ) = \frac{{C}_{r} \cdot {C}_{{r}_{m}} + {C}_{g} \cdot {C}_{{g}_{m}} + {C}_{b} \cdot {C}_{{b}_{m}}}{{C}_{{r}_{m}}^{2} + {C}_{{g}_{m}}^{2} + {C}_{{b}_{m}}^{2}} , \qquad ( 2 )$$

where \vec{C}={Cᵣ, C_{g}, C_{b}} is a pixel or segment colour with rgb components, and \vec{C}ₘ={Cᵣ_{ₘ}, C_{g}_{ₘ}, C_{b}_{ₘ}} is the corresponding trained mean for the pixel or segment colour in the trained background model.

The chroma distortion can be simply expressed as:

$$CD ( \vec{C} ) = \sqrt{\frac{( {( {C}_{r} - BD ( \vec{C} ) \cdot {C}_{{r}_{m}} )}^{2} + ( {C}_{g} - BD ( \vec{C} ) \cdot }{{… {C}_{{g}_{m}} )}^{2} + {( {C}_{b} - BD ( \vec{C} ) \cdot {C}_{{b}_{m}} )}^{2} )}} . \qquad ( 3 )$$

Based on these, the method comprises defining the cost for Background as:

$${Cost}_{BG} ( \vec{C} ) = \frac{{‖ \vec{C} - {\vec{C}}_{m} ‖}^{2}}{5 \cdot {σ}_{m}^{2} \cdot {K}_{1}} + \frac{{CD ( \vec{C} )}^{2}}{5 \cdot {σ}_{{CD}_{m}}^{2} \cdot {K}_{2}} + … \frac{{‖ ToF - {ToF}_{m} ‖}^{2}}{5 \cdot {σ}_{{ToF}_{m}}^{2} \cdot {K}_{5}} , \qquad ( 4 )$$

where σₘ² represents the variance of that pixel or segment in the background, σ_{CD}_{ₘ}²s the one corresponding to the chromatic distortion, σ_{ToF}_{ₘ}² is the variance of a trained background depth model, ToF is the measured depth and ToFₘ is the trained depth mean for a given pixel or segment in the background.
Akin to [5], the foreground cost can be just defined as:

$${Cost}_{FG} ( \vec{C} ) = \frac{16.64 \cdot {K}_{3}}{5} . \qquad ( 5 )$$

The cost related to shadow probability is defined by the method of the first aspect of the invention as:

$${Cost}_{SH} ( \vec{C} ) = \frac{{CD ( \vec{C} )}^{2}}{5 \cdot {σ}_{{CD}_{m}}^{2} \cdot {K}_{2}} + \frac{5 \cdot {K}_{4}}{{BD ( \vec{C} )}^{2}} + … \frac{{‖ ToF - {ToF}_{m} ‖}^{2}}{5 \cdot {σ}_{{ToF}_{m}}^{2} \cdot {K}_{5}} - log ( 1 - \frac{1}{\sqrt{2 \cdot π \cdot {σ}_{m}^{2} \cdot {K}_{1}}} ) . \qquad ( 6 )$$

In (4), (5) and (6), K₁, K₂, K₃, K₄ and K₅ are adjustable proportionality constants corresponding to each of the distances in use in the costs above. In this invention, thanks to the normalization factors in the expressions, once fixed all Kₓ parameters, results remain quite independent from scene, not needing additional tuning based on content.

The cost functionals described above, while applicable pixel-wise in a straightforward way, would not provide satisfactory enough results if not used in a more structured computational framework. Robust segmentation requires, at least, to exploit the spatial structure of content beyond pixel-wise cost measure of foreground, background and shadow classes. For this purpose, in this invention, pixels' costs are locally estimated as an average over temporally stable, homogeneous colour regions [8] and then further regularized through a global optimization algorithm such as hierarchical believe propagation. That's carried out by the above referred steps i) to iv).

First of all, in step i), the image is over-segmented using homogeneous colour criteria. This is done by means of a k-means approach. Furthermore, in order to ensure temporal stability and consistency of homogeneous segments, a temporal correlation is enforced on k-means colour centroids in step ii) (final resulting centroids after k-means segmentation of a frame are used to initialize the over-segmentation of the next one). Then segmentation model costs are computed per colour segment, in step iii). According to the method of the first aspect of the invention, the computed costs per segment include colour information as well information related to the difference between foreground depth information with respect to the background.

After colour-depths costs are computed, for carrying out said more global exploiting, a step iv) is carried out, i.e. using an optimization algorithm, such as hierarchical Belief Propagation [9], to find the best possible global solution (at a picture level) by optimizing and regularizing costs.

Optionally, and after step iv) has been carried out, the method comprises performing the final decision pixel or region-wise on final averaged costs computed over uniform colour regions to further refine foreground boundaries.

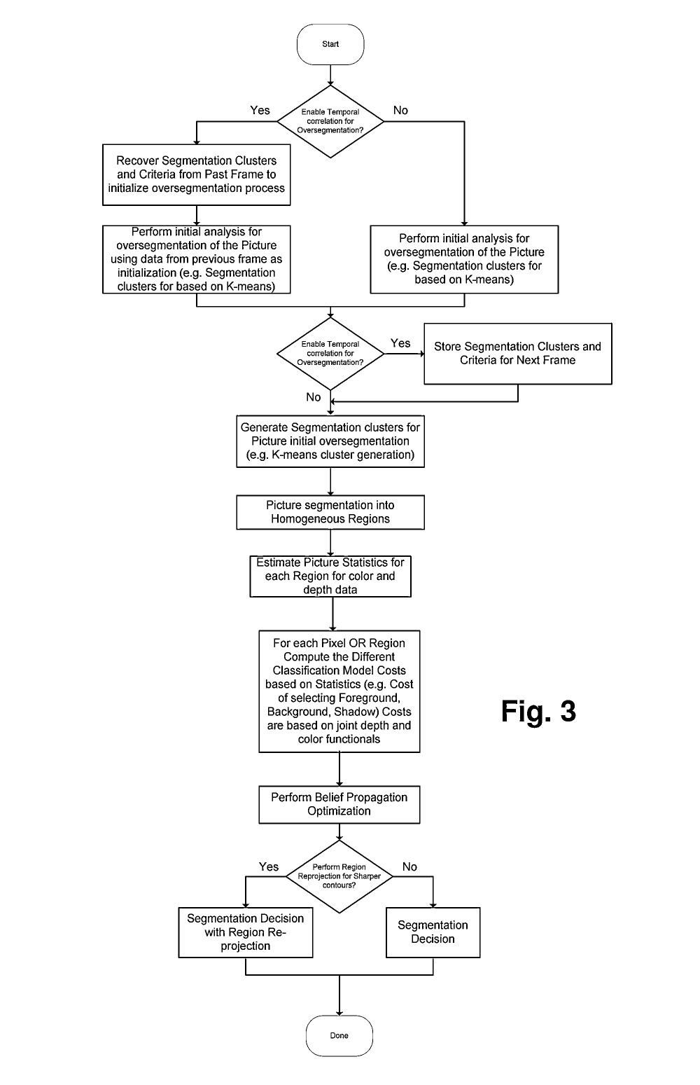

FIG. 3 depicts the block architecture of an algorithm implementing said steps i) to iv), and other steps, of the method of the first aspect of the invention.

In order to use the image's local spatial structure in a computationally affordable way, several methods have been considered taking into account also common hardware usually available in consumer or workstation computer systems. For this, while a large number of image segmentation techniques are available, they are not suitable to exploit the power of parallel architecture such as Graphics Processing Units (GPU) available on computers nowadays. Knowing that the initial segmentation is just going to be used as a support stage for further computation, a good approach for said step i) is a k-means clustering based segmentation [11]. K-means clustering is a well known algorithm for cluster analysis used in numerous applications. Given a group of samples (x₁, x₂, . . . , xₙ), where each sample is a d-dimensional real vector, in this case (R,G,B, x, y), where R, G and B are pixel colour components, and x, y are its coordinates in the image space, it aims to partition the n samples into k sets S=S₁, S₂, . . . , Sₖ such that:

$${arg min}_{s} {\sum }_{i = 1}^{k} {\sum }_{{X}_{j} ∈ {S}_{i}} {‖ {X}_{j} - {μ}_{i} ‖}^{2} ,$$

where μᵢ is the mean of points in Sᵢ. Clustering is a hard time consuming process, mostly for large data sets.

The common k-means algorithm proceeds by alternating between assignment and update steps:
Assignment: Assign each sample to the cluster with the closest mean.

Sᵢ^{(t)}={Xⱼ:∥Xⱼ−μᵢ^{(t)}∥≦∥Xⱼ−μ_{i*}^{(t)}∥, . . . ∀i*=1, . . . k}
Update: Calculate the new means to be the centroid of the cluster.

$${μ}_{i}^{( t + 1 )} = \frac{1}{\vert {S}_{i}^{( t )} \vert} {\sum }_{{X}_{j} ∈ {S}_{i}^{( t )}} {X}_{j}$$

The algorithm converges when assignments no longer change.

According to the method of the first aspect of the invention, said k-means approach is a k-means clustering based segmentation modified to fit better to the problem and the particular GPU architecture (i.e. number of cores, threads per block, etc . . . ) to be used.

Modifying said k-means clustering based segmentation comprises constraining the initial Assignment set (μₗ⁽¹⁾, , , μₖ⁽¹⁾) to the parallel architecture of GPU by means of a number of sets that also depend on the image size. The input is split into a grid of n×n squares, achieving

$$\frac{( M \times N )}{{n}^{2}}$$

clusters where N and M are the image dimensions. The initial Update step is computed from the pixels within these regions. With this the algorithm is helped to converge in a lower number of iterations.

A second constraint introduced, as part of said modification of the k-means clustering based segmentation, is in the Assignment step. Each pixel can only change cluster assignment to a strictly neighbouring k-means cluster such that spatial continuity is ensured.

The initial grid, and the maximum number of iterations allowed, strongly influences the final size and shape of homogeneous segments. In these steps, n is related to the block size used in the execution of process kernels within the GPU. The above constraint leads to:

Sᵢ^{(t)}={Xⱼ:∥Xⱼ−μᵢ^{(t)}∥≦∥Xⱼ−μᵢ^{(t)}∥, ∀i*∈N(i)}

where N (i) is the neighbourhood of cluster i (in other words the set of clusters that surround cluster i), and X is a vector representing a pixel sample (R, G, B, x, y), where R, G, B represent colour components in any selected colour space and x, y are the spatial position of said pixel in one of said pictures.

For a preferred embodiment the method of the first aspect of the invention is applied to a plurality of images corresponding to different and consecutive frames of a video sequence.

For video sequences where there is a strong temporal correlation from frame to frame, the method further comprises using final resulting centroids after k-means segmentation of a frame to initialize the oversegmentation of the next one, thus achieving said enforcing of a temporal correlation on k-means colour centroids, in order to ensure temporal stability and consistency of homogeneous segments of step ii). In other words, this helps to further accelerate the convergence of the initial segmentation while also improving the temporal consistency of the final result between consecutive frames.

Resulting regions of the first over-segmentation step of the method of the invention are small but big enough to account for the image's local spatial structure in the calculation. In terms of implementation, in an embodiment of this invention, the whole segmentation process is developed in CUDA (NVIDIA C extensions for their graphic cards). Each step, assignment and update, are built as CUDA kernels for parallel processing. Each of the GPU's thread works only on the pixels within a cluster. The resulting centroid data is stored as texture memory while avoiding memory misalignment. A CUDA kernel for the Assignment step stores per pixel in a register the decision. The

Update CUDA kernel looks into the register previously stored in texture memory and computes the new centroid for each cluster. Since real-time is a requirement for our purpose, the number of iterations can be limited to n, where n is the size of initialization grid in this particular embodiment.

After the initial geometric segmentation, the next step is the generation of the region-wise averages for chromatic distortion (CD), Brightness (BD) and other statistics required in Foreground/Background/Shadow costs. Following to that, the next step is to find a global solution of the foreground segmentation problem. Once we have considered the image's local spatial structure through the regularization of the estimation costs on the segments obtained via our customized k-means clustering method, we need a global minimization algorithm to exploit global spatial structure which fits our real-time constraints. A well known algorithm is the one introduced in [9], which implements a hierarchical belief propagation approach. Again, a CUDA implementation of this algorithm is in use in order to maximize parallel processing within every of its iterations. Specifically, in an embodiment of this invention three levels are being considered in the hierarchy with 8, 2 an 1 iterations per level (from finer to coarser resolution levels). In an embodiment of the invention, one can assign less iterations for coarser layers of the pyramid, in order to balance speed of convergence with resolution losses on the final result. A higher number of iterations in coarser levels makes the whole process converge faster but also compromises the accuracy of the result on small details. Finally, the result of the global optimization step is used for classification based on (1), either pixel-wise or region-wise with a re-projection into the initial regions obtained from the first over-segmentation process in order to improve the boundaries accuracy.

For an embodiment, the method of the invention comprises using the results of step iv) to carry out a classification based on either pixel-wise or region-wise with a re-projection into the segmentation space in order to improve the boundaries accuracy of said foreground.

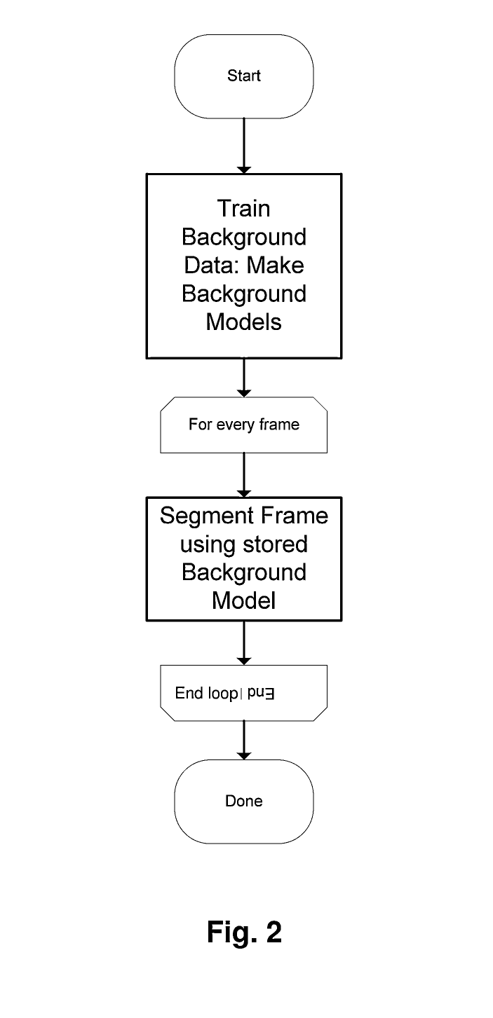

Referring now to the flowchart of FIG. 2, there a general segmentation approach used to process sequentially each picture, or frame of a video sequence, according to the method of the first aspect of the invention, is shown, where Background models based on colour and depth statistics are made from trained Background data.

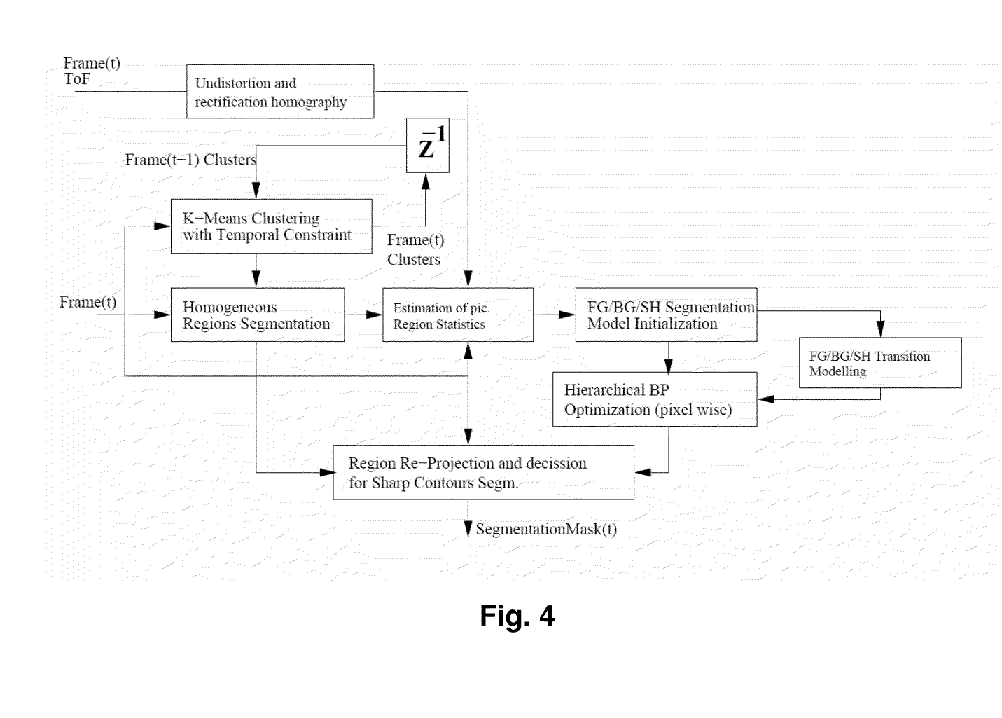

FIG. 4 shows the general block diagram related to the method of the first aspect of the invention. It basically shows the connectivity between the different functional modules that carry out the segmentation process.

As seen in the picture, every input frame is processed in order to generate a first over-segmented result of connected regions. This is done in a Homogeneous Regions segmentations process, which among other, can be based on a region growing method using K-means based clustering. In order to improve temporal and spatial consistency, segmentation parameters (such as k-means clusters) are stored from frame to frame in order to initialize the over-segmentation process in the next input frame.

The first over-segmented result is then used in order to generate regularized region-wise statistical analysis of the input frame. This is performed region-wise, such that colour, brightness, or other visual features are computed in average (or other alternatives such as median) over each region. Such region-wise statistics are then used to initialize a region or pixel-wise foreground/Background shadow Costs model. This set of costs per pixel or per region is then cross-optimized by an optimization algorithm that, among other may be Belief Propagation for instance. In this invention, a rectified and registered depth version of the picture is also input in order to generate the cost statistics for joint colour-depth segmentation costs estimation.

After optimizing the initial Foreground/Background/Shadow costs, these are then analyzed in order to decide what is foreground and what background is. This is done either pixel wise or it can also be done region-wise using the initial regions obtained from the over-segmentation generated at the beginning of the process.

The above indicated re-projection into the segmentation space, in order to improve the boundaries accuracy of the foreground, is also included in the diagram of FIG. 4, finally obtaining a segmentation mask or segment as the one corresponding to the right middle view of FIG. 1, and a masked scene as the one of the right bottom view of FIG. 1.

FIG. 3 depicts the flowchart corresponding to the segmentation processes carried by the method of the first aspect of the invention, for an embodiment including different alternatives, such as the one indicated by the disjunctive box, questioning if performing a region reprojection for sharper contours.

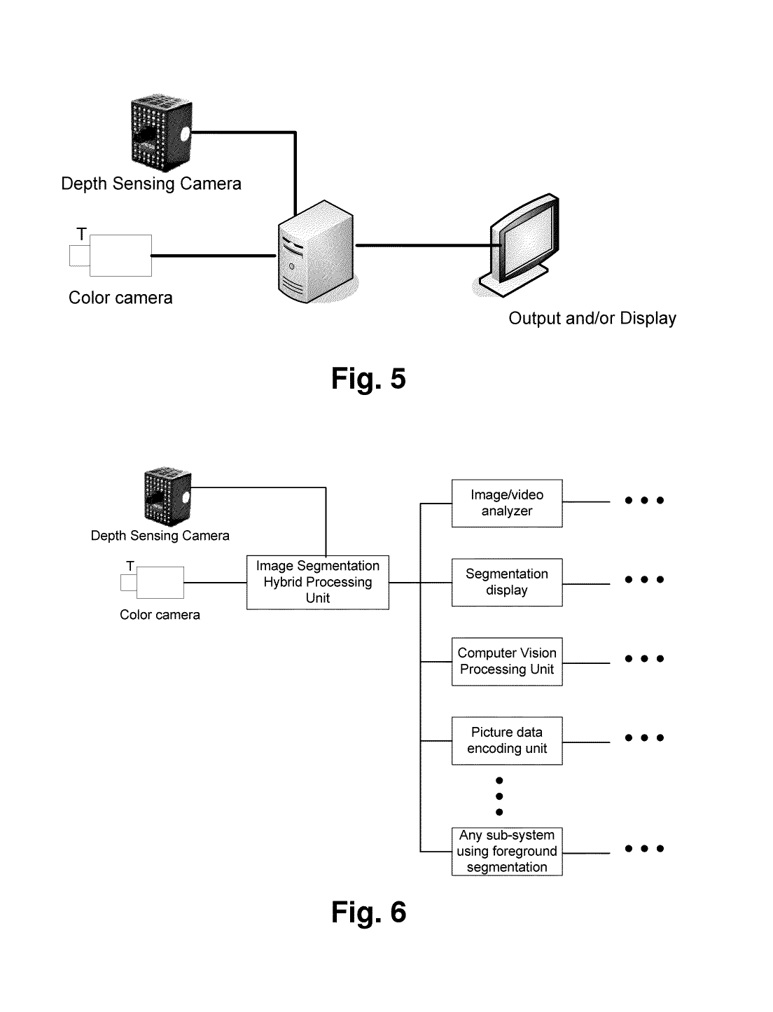

Regarding the system provided by the second aspect of the invention, which involves the capture of two modalities from a scene composed by colour picture data and depth picture data, FIG. 5 illustrates a basic embodiment thereof, including a colour camera to acquire colour images, a depth sensing camera for acquiring depth information, a processing unit comprised by the previously indicated processing means, and an output and/or display for delivering the results obtained.

Said processing unit can be any computationally enabled device, such as dedicated hardware, a personal computer, and embedded system, etc . . . and the output of such a system after processing the input data can be used for display, or as input of other systems and sub-systems that use a foreground segmentation.

For some embodiments, the processing means are intended also for generating real and/or virtual three-dimensional images, from silhouettes generated from the images foreground segmentation, and displaying them through said display.

For an embodiment, the system constitutes or forms part of a Telepresence system.

A more detailed example is shown in FIG. 6, where it depicts that after the processing unit that creates a hybrid (colour and depth) segmented version of the input and that as output can give the segmented result plus, if required, additional data at the input of the segmentation module. The hybrid input of the foreground segmentation module (an embodiment of this invention) can be generated by any combination of devices able to generate both depth and colour picture data modalities. In the embodiment of FIG. 6, this is generated by two cameras (one for colour and the other for depth—e.g. a ToF camera—). The output can be used in at least one of the described processes: image/video analyzer, segmentation display, computer vision processing unit, picture data encoding unit, etc . . .

For implementing the system of the second aspect of the invention in a real case, in order to capture colour and depth information about the scene, two cameras have been used by the inventor. Indeed, no real HD colour+depth camera is available in the market right now; and active depth sensitive cameras such as ToF are only available with quite small resolution. Thus, for said implementing of an embodiment of the system of the second aspect of the invention, a high resolution 1338×1038 camera and a SR4000 ToF camera have been used. In order to fuse both colour and depth information using the above described costs, depth information from SR4000 camera needs to be undistorted, rectified and scaled up to fit with colour camera captured content. Since both cameras have different optical axes, they can only be properly rectified for a limited depth range. In this work, the homography applied on the depth picture is optimized to fit the scene region where tests are to be performed.

For other embodiments, not illustrated, a hybrid camera could as well be used where the camera is able to supply both picture data modalities: colour and depth. For such an embodiment where a camera is able to supply colour and depth information over the same optical axis, rectification would not be necessary and there would be no limitation on depth and colour correspondence depending on the depth.

In a more complex system, an embodiment of this invention can be used as an intermediate step for a more complex processing of the input data.

This invention is a novel approach for robust foreground segmentation for real-time operation on GPU architectures, and has the next advantages:
The invention includes the fusion of depth information with colour data making the segmentation more robust and resilient to foregrounds with similar colour properties with the background. Also, the cost functionals provided in this work, plus the use of over-segmented regions for statistics estimation, have been able to make the foreground segmentation more stable in space and time.
The invention exploits local and global picture structure in order to enhance the segmentation quality, its spatial consistency and stability as well as its temporal consistency and stability.
This approach is suitable for combination with other computer vision and image processing techniques such as real-time depth estimation algorithms for stereo matching acceleration, flat region outlier reduction and depth boundary enhancement between regions.
The statistical models provided in this invention, plus the use of over-segmented regions for statistics estimation have been able to make the foreground segmentation more stable in space and time, while usable in real-time on current market-available GPU hardware.
The invention also provides the functionality of being “scalable” in complexity. This is, the invention allows for adapting the trade-off between final result accuracy and computational complexity as a function of at least one scalar value. Allowing to improve segmentation quality and capacity to process bigger images as GPU hardware becomes better and better.
The invention provides a segmentation approach that overcomes limitations of currently available state of the art. The invention does not rely on ad-hoc closed-contour object models, and allows detecting and to segment foreground objects that include holes and highly detailed contours.
The invention provides also an algorithmic structure suitable for easy, parallel multi-core and multi-thread processing.
The invention provides a segmentation method resilient to shading changes and resilient to foreground areas with weak discrimination with respect to the background if these “weak” areas are small enough.
The invention does not rely on any high level model, making it applicable in a general manner to different situations where foreground segmentation is required (independently of the object to segment or the scene).

A person skilled in the art could introduce changes and modifications in the embodiments described without departing from the scope of the invention as it is defined in the attached claims.

### REFERENCES

[1]O. Divorra Escoda, J. Civit, F. Zuo, H. Belt, I. Feldmann, O. Schreer, E. Yellin, W. Ijsselsteijn, R. van Eijk, D. Espinola, P. Hagendorf, W. Waizenneger, and R. Braspenning, “Towards 3d-aware telepresence: Working on technologies behind the scene,” in New Frontiers in Telepresence workshop at ACM CSCW, Savannah, Ga., February 2010.

[2] C. L. Kleinke, “Gaze and eye contact: A research review, “Psychological Bulletin, vol. 100, pp. 78-100, 1986. [3] A. Elgammal, R. Duraiswami, D. Harwood, and L. S. Davis, “Non-parametric model for background subtraction,” in Proceedings of International Conference on Computer Vision. September 1999, IEEE Computer Society.

[3] T. Horpraset, D. Harwood, and L. Davis, “A statistical approach for real-time robust background subtraction and shadow detection,” in IEEE ICCV, Kerkyra, Greece, 1999.

[4] J. L. Landabaso, M. Pard'as, and L.-Q. Xu, “Shadow removal with blob-based morphological reconstruction for error correction,” in IEEE ICASSP, Philadelphia, Pa., USA, March 2005.

[5] J.-L. Landabaso, J.-C Pujol, T. Montserrat, D. Marimon, J. Civit, and O. Divorra, “A global probabilistic framework for the foreground, background and shadow classification task,” in IEEE ICIP, Cairo, November 2009.

[6] J. Gallego Vila, “Foreground segmentation and tracking based on foreground and background modelling techniques,” M.S. thesis, Image Processing Department, Technical University of Catalunya, 2009.

[7] I. Feldmann, O. Schreer, R. Shfer, F. Zuo, H. Belt, and O. Divorra Escoda, “Immersive multi-user 3d video communication,” in IBC, Amsterdam, The Netherlands, September 2009.

[8] C. Lawrence Zitnick and Sing Bing Kang, “Stereo for image based rendering using image over-segmentation,” in International Journal in Computer Vision, 2007.

[9] P. F. Felzenszwalb and D. P. Huttenlocher, “Efficient belief propagation for early vision,” in CVPR, 2004, pp. 261-268.

[10] J. B. MacQueen, “Some methods for classification and analysis of multivariate observations,” in Proc. of the fifth Berkeley Symposium on Mathematical Statistics and Probability, L. M. Le Cam and J. Neyman, Eds. 1967, vol. 1, pp. 281-297, University of California Press.

[11] O. Schreer N. Atzpadin, P. Kauff, “Stereo analysis by hybrid recursive matching for real-time immersive video stereo analysis by hybrid recursive matching for real-time immersive video conferencing,” vol. 14, no. 3, March 2004.

[12] R. Crabb, C. Tracey, A. Puranik, and J. Davis. Real-time foreground segmentation via range and colour imaging. In IEEE CVPR, Anchorage, Alaska, June 2008.

[13] A. Bleiweiss and M. Werman. Fusing time-of-flight depth and colour for real-time segmentation and tracking. In DAGM 2009 Workshop on Dynamic 3D Imaging, Saint Malo, France, October 2009.

1. Method for images foreground segmentation in real-time, comprising:
generating a set of cost functions for foreground, background and shadow segmentation classes or models, where the background and shadow segmentation cost functionals are a function of chromatic distortion and brightness and colour distortion, and where said cost functions are related to probability measures of a given pixel or region to belong to each of said segmentation classes; and
applying to pixel data of an image said set of generated cost functions;
said method being characterised in that it comprises defining said background and shadow segmentation models introducing depth information of the scene said image has been acquired of.

2. Method as per claim 1, comprising defining said segmentation models according to a Bayesian formulation.

3. Method as per claim 2, comprising, in addition to a local modelling of foreground, background and shadow classes carried out by said cost functions where image structure is exploited locally, exploiting the spatial structure of content of at least said image in a more global manner.

4. Method as per claim 3, wherein said exploiting of the local spatial structure of content of at least said image is carried out by estimating costs as an average over homogeneous colour regions.

5. Method as per claim 1, comprising applying a logarithm operation to the probability expressions, or cost functions, generated in order to derive additive costs.

6. Method as per claim 1, comprising defining said brightness distortion as:
$$BD ( \vec{C} ) = \frac{{C}_{r} \cdot {C}_{{r}_{m}} + {C}_{g} \cdot {C}_{{g}_{m}} + {C}_{b} \cdot {C}_{{b}_{m}}}{{C}_{{r}_{m}}^{2} + {C}_{{g}_{m}}^{2} + {C}_{{b}_{m}}^{2}}$$
where \vec{C}={Cᵣ, C_{g}, C_{b}} is a pixel or segment colour with rgb components, and \vec{C}ₘ={Cᵣ_{ₘ}, C_{g}_{ₘ}, C_{b}_{ₘ}} is the corresponding trained mean for the pixel or segment colour in a trained background model.

7. Method as per claim 6, comprising defining said chromatic distortion as:
$$CD ( \vec{C} ) = \sqrt{\frac{( {( {C}_{r} - BD ( \vec{C} ) \cdot {C}_{{r}_{m}} )}^{2} + ( {C}_{g} - BD ( \vec{C} ) \cdot }{{… {C}_{{g}_{m}} )}^{2} + {( {C}_{b} - BD ( \vec{C} ) \cdot {C}_{{b}_{m}} )}^{2} )}} .$$

8. Method as per claim 7, comprising defining said cost function for the background segmentation class as:
$${Cost}_{BG} ( \vec{C} ) = \frac{{‖ \vec{C} - {\vec{C}}_{m} ‖}^{2}}{5 \cdot {σ}_{m}^{2} \cdot {K}_{1}} + \frac{{CD ( \vec{C} )}^{2}}{5 \cdot {σ}_{{CD}_{m}}^{2} \cdot {K}_{2}} + … \frac{{‖ ToF - {ToF}_{m} ‖}^{2}}{5 \cdot {σ}_{{ToF}_{m}}^{2} \cdot {K}_{5}} ,$$
where K₁, K₂ and K₅ are adjustable proportionality constants corresponding to the distances in use in said background cost function, σₘ² represents the variance of that pixel or segment in a trained background model, σ_{CD}_{ₘ}² is the one corresponding to the chromatic distortion, σ_{ToF}_{ₘ}² is the variance of a trained background depth model, ToF is the measured depth and ToFₘ is the trained depth mean for a given pixel or segment in the background.

9. Method as per claim 8, comprising defining said cost function for the foreground segmentation class as:
$${Cost}_{FG} ( \vec{C} ) = \frac{16.64 \cdot {K}_{3}}{5} .$$
where K₃ is an adjustable proportionality constant corresponding to the distances in use in said foreground cost function.

10. Method as per claim 9, comprising defining said cost function for the shadow class as:
$${Cost}_{SH} ( \vec{C} ) = \frac{{CD ( \vec{C} )}^{2}}{5 \cdot {σ}_{{CD}_{m}}^{2} \cdot {K}_{2}} + \frac{5 \cdot {K}_{4}}{{BD ( \vec{C} )}^{2}} + … \frac{{‖ ToF - {ToF}_{m} ‖}^{2}}{5 \cdot {σ}_{{ToF}_{m}}^{2} \cdot {K}_{5}} - log ( 1 - \frac{1}{\sqrt{2 \cdot π \cdot {σ}_{m}^{2} \cdot {K}_{1}}} ) .$$
where K₄ and K₅ are adjustable proportionality constants corresponding to the distances in use in said shadow cost function.

11. Method as per claim 4, wherein said estimating of pixels' costs is carried out by the next sequential actions:
i) over-segmenting the image using a homogeneous colour criteria based on a k-means approach;
ii) enforcing a temporal correlation on k-means colour centroids, in order to ensure temporal stability and consistency of homogeneous segments,
iii) computing said cost functions per homogeneous colour segment; and
wherein said exploiting of the spatial structure of content of at least said image in a more global manner is carried out by the next action:
iv) using an optimization algorithm to find the best possible global solution by optimizing costs.

12. Method as per claim 11, wherein said optimization algorithm is a hierarchical Belief Propagation algorithm.

13. Method as per claim 11, comprising, after said step iv) has been carried out, performing the final decision pixel or region-wise on final averaged costs computed over uniform colour regions to further refine foreground boundaries.

14. Method as per claim 11, wherein said k-means approach is a k-means clustering based segmentation modified to fit a graphics processing unit, or GPU, architecture.

15. Method as per claim 14, wherein modifying said k-means clustering based segmentation comprises constraining the initial Assignment set (μ₁⁽¹⁾ , , , μₖ⁽¹⁾) to the parallel architecture of GPU by means of a number of sets that also depend on the image size, by means of splitting the input into a grid of n×n squares, where n is related to the block size used in the execution of process kernels within the GPU, achieving
$$\frac{( M \times N )}{{n}^{2}}$$
clusters, where N and M are the image dimensions, and μᵢ is the mean of points in set of samples Sᵢ, and computing the initial Update step of said k-means clustering based segmentation from the pixels within said squared regions, such that an algorithm implementing said modified k-means clustering based segmentation converges in a lower number of iterations.

16. Method as per claim 15, wherein modifying said k-means clustering based segmentation further comprises, in the Assignment step of said k-means clustering based segmentation, constraining the clusters to which each pixel can change cluster assignment to a strictly neighbouring k-means cluster, such that spatial continuity is ensured.

17. Method as per claim 16, wherein said constraints lead to the next modified Assignment step:
Sᵢ^{(t)}={Xⱼ:∥Xⱼ−μᵢ^{(t)}∥≦∥Xⱼ−μᵢ^{(t)}∥, ∀i*∈N(i)}
where N (i) is the neighbourhood of cluster i, and Xⱼ is a vector representing a pixel sample,
(R,G,B,x,y) B represent colour components in any selected colour space and x, y are the spatial position of said pixel in one of said pictures.

18. Method as per claim 1, wherein it is applied to a plurality of images corresponding to different and consecutive frames of a video sequence.

19. Method as per claim 17, the method applied to a plurality of images corresponding to different and consecutive frames of a video sequence, wherein for video sequences where there is a strong temporal correlation from frame to frame, the method comprises using final resulting centroids after k-means segmentation of a frame to initialize the oversegmentation of the next one, thus achieving said enforcing of a temporal correlation on k-means colour centroids, in order to ensure temporal stability and consistency of homogeneous segments.

20. Method as per claim 19, comprising using the results of step iv) to carry out a classification based on either pixel-wise or region-wise with a re-projection into the segmentation space in order to improve the boundaries accuracy of said foreground.

21. Method as per claim 1, wherein said depth information is a processed depth information obtained by acquiring rough depth information with a Time of Flight, ToF, camera and processing it to undistort, rectify and scale it up to fit with colour content, regarding said image, captured with a colour camera.

22. Method as per claim 1, comprising acquiring both, colour content, regarding said image, and said depth information with one and only camera able to acquire and supply colour and depth information.

23. System for images foreground segmentation in real-time, comprising camera means intended for acquiring images from a scene, including colour information, processing means connected to said camera to receive images acquired there by, and to process them in order to carry out a real-time images foreground segmentation, characterised in that said camera means are also intended for acquiring, from said scene, depth information, and in that said processing means are intended for carrying out said foreground segmentation by hardware and/or software elements implementing at least said applying of said cost functions of the method as per claim 1.

24. System as per claim 23, wherein said hardware and/or software elements implement the following steps i) to iv):
i) over-segmenting the image using a homogeneous colour criteria based on a k-means approach;
ii) enforcing a temporal correlation on k-means colour centroids, in order to ensure temporal stability and consistency of homogeneous segments,
iii) computing said cost functions per homogeneous colour segment; and
wherein said exploiting of the spatial structure of content of at least said image in a more global manner is carried out by the next action:
iv) using an optimization algorithm to find the best possible global solution by optimizing costs.

25. System as per claim 23, wherein said camera means comprises a colour camera for acquiring said images including colour information, and a Time of Flight, ToF, camera for acquiring said depth information.

26. System as per claim 23, wherein said camera means comprises one and only camera able to acquire and supply colour and depth information.

27. System as per claim 23, comprising a display connected to the output of said processing means, the latter being intended also for generating real and/or virtual three-dimensional images, from silhouettes generated from said images foreground segmentation, and displaying them through said display.

28. System as per claim 27, characterised in that it constitutes or forms part of a Telepresence system.
